(19) United States
(12) Patent Application Publication
(10) Pub. No.: US 2003/0234503 A1
(43) Pub. Date: Dec. 25, 2003

(54) Golf bag with moveable support

(76) Inventor: Chin-Chu Chiang, Taichung (TW)

Correspondence Address: Chin-Chu Chiang, 12 Arrivo Drive, Mission Viejo, CA, 92692, US

(21) Appl. No.: 10/178,012

(22) Filed: Jun. 20, 2002

(51) Int. Cl. B62B 1/00

(52) U.S. Cl. 280/47.131

(57) ABSTRACT

A golf bag includes a cylindrical base having a top fact to which a bag body is integrally or removably mounted and a side surface on which a ledge is formed. A bore is defined through the ledge between opposite end faces of the ledge for movably receiving two bars therein with remote end sections of the bars extending beyond the end faces of the ledge to rotatably support wheels thereon. Thus, the wheels can be moved between a retracted position and an extended position where the wheels are located away from the bag body for more firmly supporting the bag. A channel is defined inside the base for movably receiving an outrigger arm that is selectively extending away from the side surface of the base whereby a remote end of the outrigger arm forms a triangle with the wheels to firmly support the bag body.

### BACKGROUND OF THE INVENTION

1. Field of the Invention

The present invention relates generally to a golf bag, and in particular to a golf bag with a moveable support for easy movement and firm support of the golf bag in a standing up but slightly inclined condition for easy access of the golf clubs.

2. The Related Art

Golf is a popular sport. A golf player must carry a set of golf clubs walking around a large course to play golf. The clubs together with the putters are usually placed in a golf bag, which is very heavy. Some may prefer to take a golf cart in moving around the golf course. However, one still need to move the golf bag from one's car to the golf cart. This causes certain inconvenience to the golf player, especially for those aged.

A trolley for carrying the golf bag is known already. However, such a conventional golf bag trolley is a separate device that is not fixed to the golf bag itself. Fastening means is provided to releasably secure the golf bag to the trolley. A user may need to frequently securing and releasing the golf bag when playing golf. This is of course disadvantageous.

A golf bag fixedly mounted to a trolley is also known. However, the trolley is large, bulky and heavy, causing problems in moving around the golf course. In addition, the conventional golf bag trolley is not suitable for moving in an uneven surface. This makes it very difficult to use in some areas of a golf course. Further, such a conventional trolley requires a great number of parts, making the costs high and maintenance difficult.

It is thus desired to have a golf bag having a moveable support for overcoming the above problems encountered in the art.

### SUMMARY OF THE INVENTION

An object of the present invention is to provide a golf bag having a moveable support that has a simple structure and light weight.

Another object of the present invention is to provide a golf bag trolley having adjustable wheels for moving in an uneven surface.

A further object of the present invention is to provide a support for retaining the golf bag in a standing up manner to allow easy access of golf clubs positioned in the bag.

To achieve the above objects, in accordance with the present invention, there is provided a golf bag comprising a cylindrical base having a top fact to which a bag body is integrally or removably mounted and a side surface on which a ledge is formed. A bore is defined through the ledge between opposite end faces of the ledge for movably receiving two bars therein with remote end sections of the bars extending beyond the end faces of the ledge to rotatably support wheels thereon. Thus, the wheels can be moved between a retracted position and an extended position where the wheels are located away from the bag body for more firmly supporting the bag. A channel is defined inside the base for movably receiving an outrigger arm that is selectively extending away from the side surface of the base whereby a remote end of the outrigger arm forms a triangle with the wheels to firmly support the bag body.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view of a golf bag constructed in accordance with the present invention comprising a moveable support or trolley;

FIG. 2 is an exploded view of the moveable support of the golf bag of the present invention;

FIG. 3 is a perspective view of the moveable support with an outrigger arm thereof detached therefrom;

FIG. 4 is another perspective view of the moveable support with wheels thereof in an extended position;

FIG. 5 is a perspective view showing the moveable support in an up-side-down fashion;

FIG. 6 is a perspective view similar to FIG. 5 but showing a moveable support constructed in accordance with a second embodiment of the present invention;

FIG. 7 is a front view of the golf bag of the present invention with the wheels in a retracted position;

FIG. 8 is similar to FIG. 7 but showing the wheels in an extended position;

FIG. 9 is a side elevational view of the golf bag of the present invention with the outrigger in an extended position;

FIG. 10 is similar to FIG. 9 but showing the outrigger in a retracted position; and

FIG. 11 is an exploded view of a moveable support constructed in accordance with a third embodiment of the present invention.

### DETAILED DESCRIPTION OF THE PREFERRED EMBODIMENTS

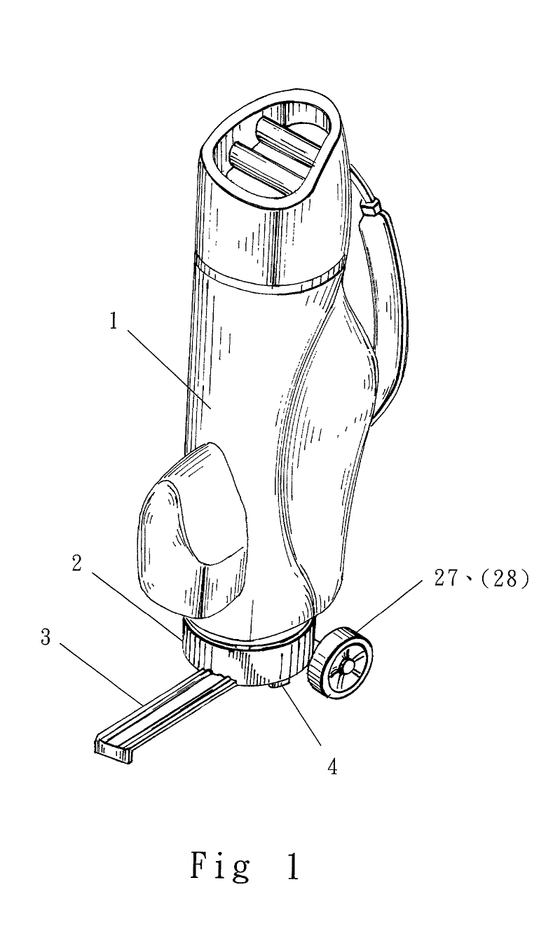

With reference to the drawings and in particular to FIG. 1, a golf bag constructed in accordance with the present invention comprises a bag body 1 fixed on a moveable support or a trolley 2. The moveable support 2 is mounted to wheels 27, 28 for moving the golf bag. An outrigger arm 3 is extendable from the support 2 for firmly supporting the bag body 1 in a standing up but slightly inclined manner to allow easy access of golf clubs (not shown) positioned in the bag body 1.

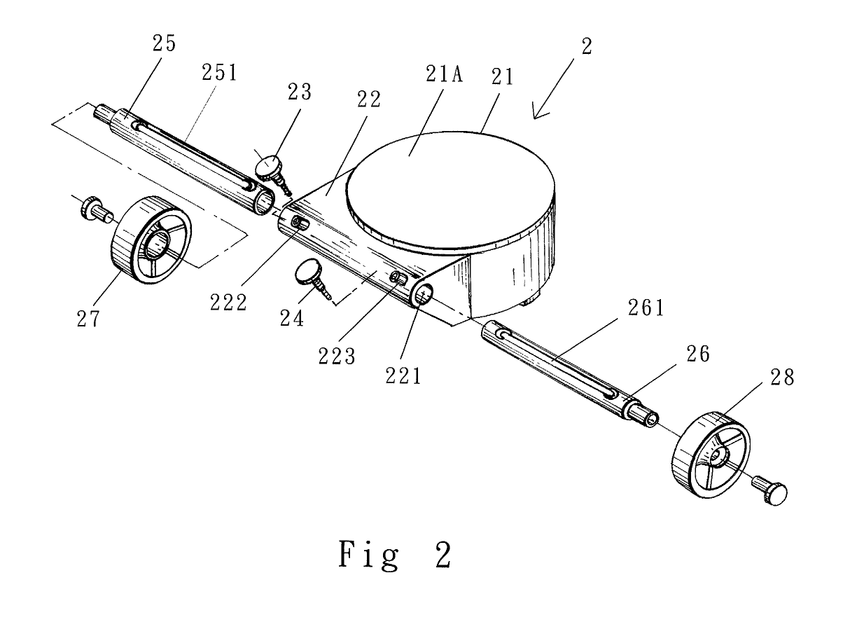

Also referring to FIG. 2, the moveable support 2 comprises a base 21 which in the embodiment illustrated is a cylinder, preferably a hollow cylindrical body having a flat top surface 21A on which the bag body 1 is fixedly or removably mounted. A ledge 22 is formed on and projects from a side surface of the base 21. A bore 221 is defined through the ledge 22 and extends horizontally in a transverse direction between opposite end faces (not labeled) of the ledge 22, defining openings (not labeled) on the opposite end faces of the ledge 22. Two bars 25, 26 are respectively received in the bore 221 through the end openings of the bore 221 whereby the bars 25, 26 are moveable with respect to the ledge 22 in an axial direction between a retracted position and an extended position. Each bar 25, 26 has a remote end section (not labeled) extending beyond the associated end opening of the bore 221 when the bars 25, 26 are at the extracted position. The wheels 27, 28 are respectively and rotatably mounted to the remote ends of the bars 25, 26 whereby the wheels 27, 28 are selectively moved from a retracted position as shown in FIGS. 1, 3 and 7 to an extended position as shown in FIGS. 4 and 8.

If necessary, the bars 25, 26 are made tubular and telescopically received in each other. In this case, the slots 251, 261 of the bars 25, 26 may partially overlap.

Two projections 222, 223 extend from the ledge 22, each defining an inner-threaded hole (not labeled) extending in a radial direction with respect to an axial direction of the bore 221. Two lock screws 23, 24 are threadingly received in the inner-threaded holes of the projections 222, 223. Each lock screw 23, 24 has a free end extending into the bore 221. Each bar 25, 26 forms an elongate slot 251, 261 partially co-extensive therewith. The free end of the lock screw 23, 24 is engageable with the slot 251, 261 of the associated bar 25, 26 for selectively fixing the wheels 27, 28 at either the retracted position or the extended position or if desired, any position between the retracted position and the extended position.

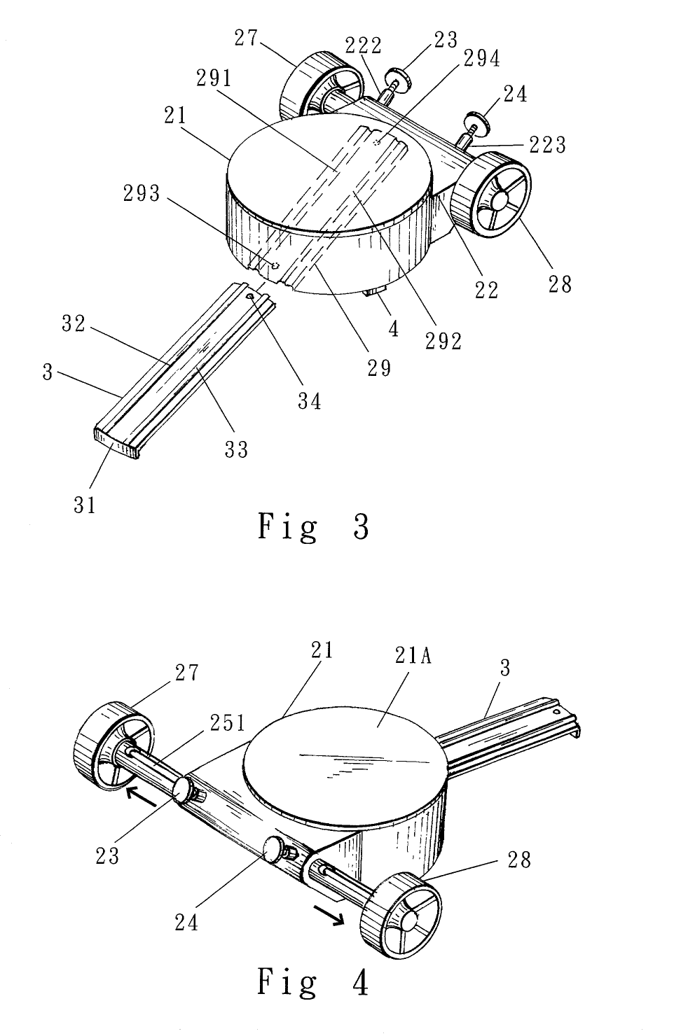

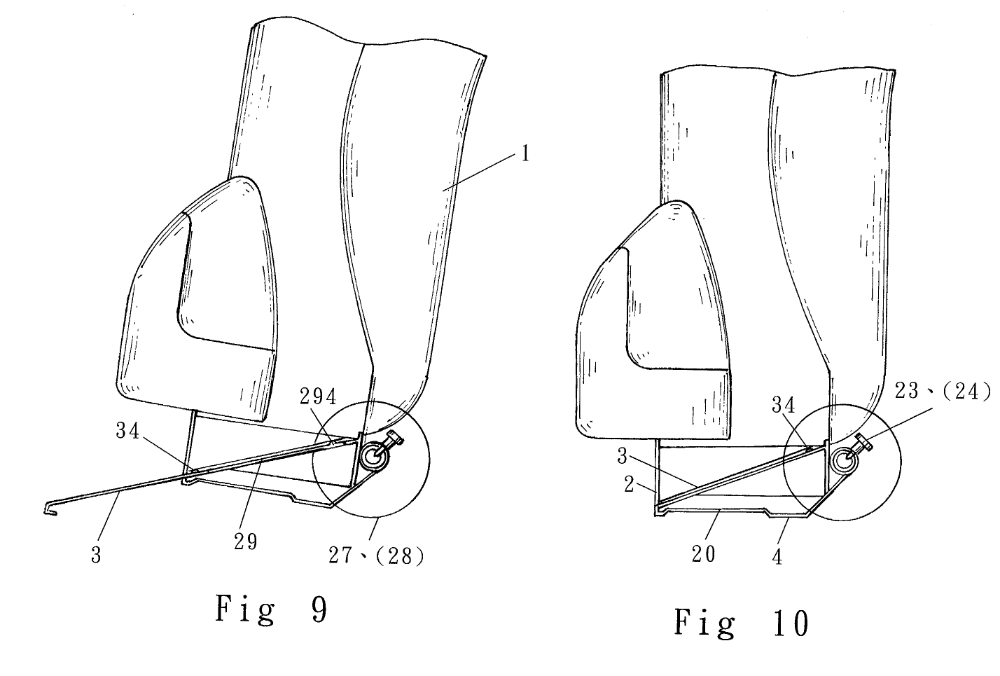

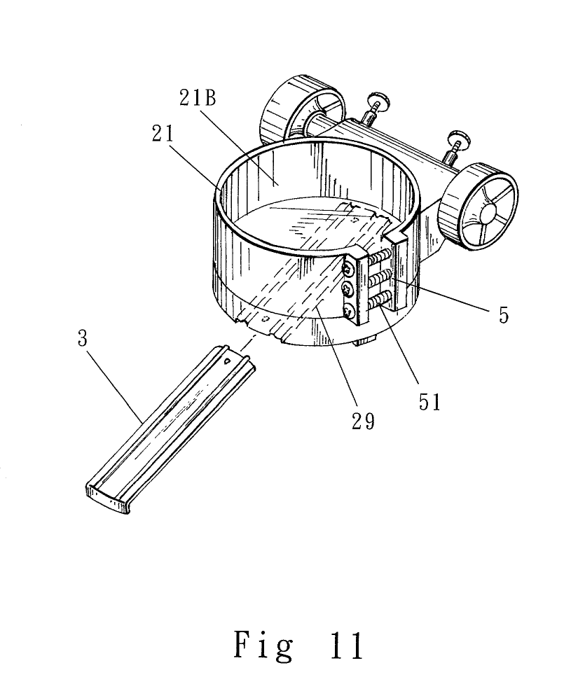

Also referring to FIGS. 3 and 4, a channel 29 is formed inside the base 21 and extends in a downward inclined fashion with respect to the flat top face 21A of the base 21 in a direction from the side of the base 21 on which the ledge 22 is formed to an opposite side of the base 21 as best seen in FIGS. 9 and 10 for movably receiving the outrigger arm 3 whereby the outrigger arm 3 is moveable between a retracted position as shown in FIG. 10 and an extended position as shown in FIG. 9. When the outrigger arm 3 is at the extended position, a remote free end of the outrigger arm 3 and the wheels 27, 28 form a triangle that firmly supports the bag body 1 in a standing up but slightly inclined manner as shown in FIG. 1.

Two recessed guide rails 291, 292 are defined in a bottom (not labeled) of the channel 29 for slidably receiving corresponding ribs 32, 33 formed on the outrigger arm 3 and guiding the movement of the outrigger arm 3 with respect to the base 21. A handle 31 is formed on the remote end of the outrigger arm 3 for manually moving the outrigger arm 3 with respect to the base 21. Preferably, a boss 34 is formed on the outrigger arm 3 for selectively and releasably engaging a dimple 293, 294 defined in the base 21 to secure the outrigger arm 3 at the extended and retracted positions.

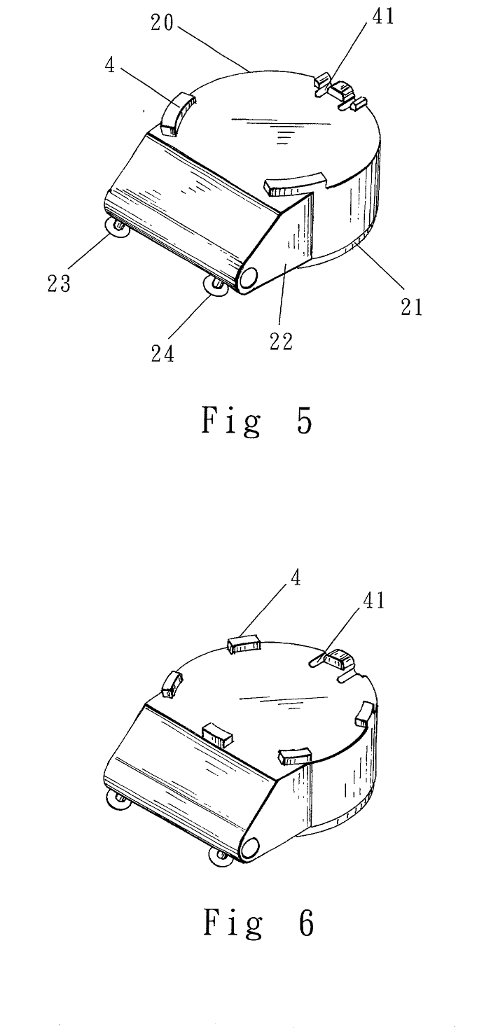

Also referring to FIG. 5, the base 21 has a bottom face 20 on which raised portions 4 are formed for supporting the base 21 on ground. In the embodiment illustrated in FIG. 5, three raised portions 4 are formed on the bottom face 20 of the base 21 and are arranged in a triangle for supporting the base 21 on the ground. Two notches 41 are defined on the bottom face 20 of the base 21 at a position corresponding to the handle 31 of the outrigger arm 3 for receiving fingers of the user to pull the outrigger arm 3 out of the channel 29.

In FIG. 6, a base 21 constructed in accordance with a second embodiment of the present invention comprises a bottom face (not labeled) on which raised portions 4 are forme . There are six such raise portions 4 forme on an equally space along a circumference of the bottom face of the base 21.

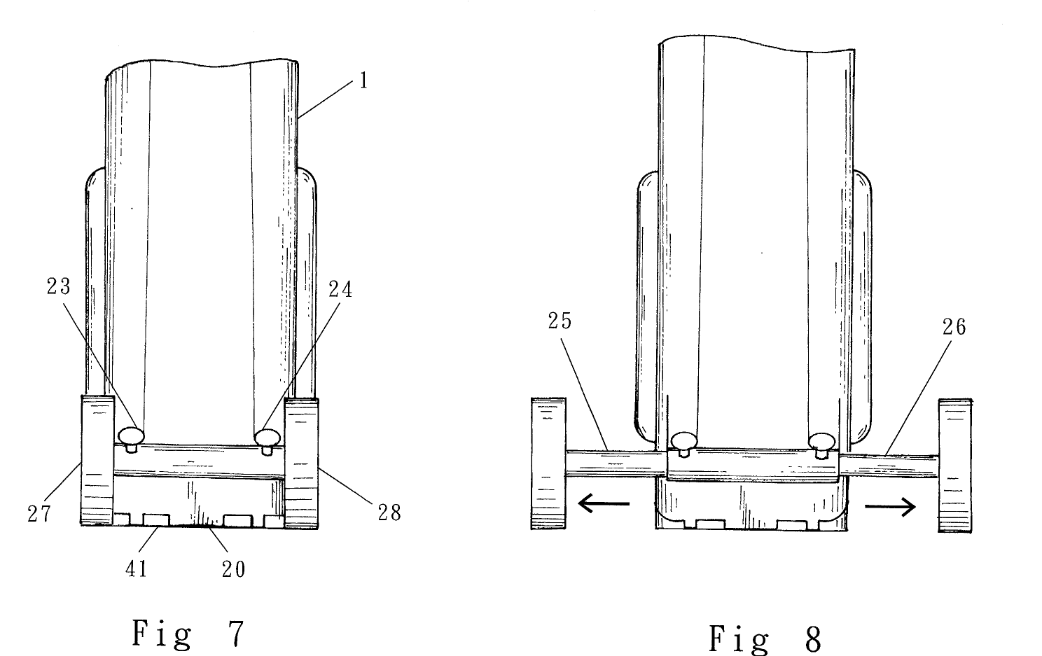

Also referring to FIGS. 7 an 8, when the moveable base 21 of the golf bag is moving on flat groun , such as pavement, the wheels 27, 28 may be secure at the retracte position. On the other han , when the moveable base 21 is moving on an uneven surface, the wheels 27, 28 may be move to the exten e position as shown in FIG. 8 for stabilizing the golf bag.

FIG. 11 shows a golf bag constructs in accor ance with a thir embo iment of the present invention. The thir embo iment is generally similar to the first embo iment. However, in the thir embo iment, a retention ring (not labele ) is mounte to the top face 21A of the base 21 an efines a space 21B on the top face 21A of the base 21 for receiving an retaining a conventional golf bag (not shown) therein. Preferably, the ring is forme by a strip surroun ing the si e surface of the base 21 an having opposite en s space from each other, forming a gap 5 therebetween. The en s of the strip are fixe together by means of bolts 51 to secure the ring to the base 21.

To this point, it is apparent that the present invention provi es a golf bag having the following a vantages:

(1) The golf bag has a base 21 having wheels 27, 28 an the wheels 27, 28 can be move to the exten e position with respect to the base 2 to allow the base 21 an thus the golf bag mounte on the base 21 to move more smooth in passing an uneven surface.

(2) The base 2 has an outrigger arm 3 that can be move to an exten e position where a remote en of the outrigger arm 3 an the wheels 27, 28 form a triangle for firmly supporting the golf bag in an stan ing up but slightly incline fashion thereby facilitating access of the clubs receive in the bag.

(3) The moveable base 2 has a simple an compact structure an can be selectively fixe to the golf bag.

Although the present invention has been described with reference to the preferred embodiments with reference to the drawings thereof, it is apparent to those skilled in the art that a variety of modifications and changes may be made without departing from the scope of the present invention which is intended to be defined by the appended claims.

What is claimed is:

1. A golf bag comprising:
a bag body adapted to receive golf clubs; and
a moveable support comprising:
a base having a top face on which the bag body is mounted and a side surface;
a ledge formed on and sideways extending from the side surface and having opposite end faces, a bore being defined in the ledge and forming opposite openings on the end faces of the ledge;
two bars movably received in the bore through the openings respectively, each bar having a remote end extending beyond the opening; the bars being moveable in an axial direction with respect to the ledge between a retracted position and an extended position; and
a wheel rotatably mounted to the end of each bar whereby the wheel is moveable with the bar in the axial direction between the retracted position and the extended position.

2. The golf bag as claimed in claim 1, wherein the bars are tubular and telescopically received in each other.

3. The golf bag as claimed in claim 1, wherein each bar defines a slot partially co-extensive therewith, an inner-threaded hole being defined in the ledge and extending in a radial direction with respect to the axial direction, a lock screw threadingly and engagingly received in the hole and having a tip end partially extending into and engaging with the slot for selectively securing the bar in the extended and retracted positions.

4. The golf bag as claimed in claim 3, wherein a projection is formed on the ledge with the inner-threaded hole defined therethrough.

5. The golf bag as claimed in claim 1 further comprising an outrigger arm selectively extending beyond the side surface of the ledge.

6. The golf bag as claimed in claim 5, wherein the outrigger arm has a remote end forms a triangle with the wheels for firmly supporting the bag body.

7. The golf bag as claimed in claim 6, wherein the outrigger arm is arranged so that the bag body that is firmly supported by the triangle is substantially standing up but slight inclined.

8. The golf bag as claimed in claim 5, wherein a channel is defined in the base for movably receiving the outrigger arm whereby the outrigger arm is moveable between a retracted position where the outrigger arm is substantially received in the channel and an extended position where the outrigger arm extends beyond the side surface of the ledge with a remote end of the outrigger arm forming a triangle with the wheels for firmly supporting the bag body.

9. The golf bag as claimed in claim 8, wherein at least one guide groove is defined in a bottom of the channel for slidably receiving a rib formed on the outrigger arm.

10. The golf bag as claimed in claim 8, wherein a boss is formed on the outrigger arm for selectively and releasably engaging dimples defined in the base for selectively retaining the outrigger arm at the retracted position and the extended position.

11. The golf bag as claimed in claim 8, wherein a handle is formed on the remote end of the outrigger arm for manually moving the outrigger arm between the extended position and the retraced position.

12. The golf bag as claimed in claim 11, wherein the base defines notches for accommodating fingers that grip the handle of the outrigger arm to manually move the outrigger arm.

13. The golf bag as claimed in claim 1, wherein the base has an opposite bottom face on which a plurality of raised portions are formed for supporting the base on ground.

14. The golf bag as claimed in claim 1, wherein a ring is mounted to the top face of the base and defines a space on the top face of the base.

15. The golf bag as claimed in claim 14, wherein the ring is made of a strip member surrounding the side surface of the base and having ends attached to each other by fasteners.
